(19) United States
(12) Patent Application Publication
(10) Pub. No.: US 2017/0361207 A1
(43) Pub. Date: Dec. 21, 2017

(54) INTERNALLY ILLUMINABLE PLAYING CARDS

(71) Applicant: Ellusionist.com, Inc., San Rafael, CA (US)

(72) Inventors: JASON BRUMBALOW, Belton, TX (US); BRAD CHRISTIAN, San Rafael, CA (US); ADAM WILBER, New Durham, NH (US); LLOYD BARNES, Porthcawl (GB); MIKE CLARKE, Keswick (CA); GERAINT CLARKE, Newport (GB); PETER MCKINNON, Keswick (CA); DANIEL MADISON, Yeadon (GB)

(73) Assignee: Ellusionist.com, Inc., San Rafael, CA (US)

(21) Appl. No.: 15/188,073

(22) Filed: Jun. 21, 2016

(51) Int. Cl. A63F 1/02; F21V 23/02; F21V 33/00; F21V 23/04; F21Y 2115/10

(52) U.S. Cl. CPC A63F 1/02; F21V 33/008; F21V 23/04; F21V 23/02; A63F 2001/022; F21Y 2115/10

(57) ABSTRACT

Internally illuminable playing cards are disclosed. The disclosed playing cards may include a polymeric body, at least one light-emitting diode (LED) at least partially inside of the polymeric body, a battery (or a slot in the polymeric body for receiving a battery) for providing power to the at least one LED, and a switch at least partially inside the polymeric body and operatively connected to the at least one LED to facilitate turning the at least one LED on and off. As can be understood based on this disclosure, the internally illuminable playing cards can be used for flourishing and cardistry techniques, in a manner similar to the way typical paper playing cards are used for such techniques.

### FIELD OF THE DISCLOSURE

The present disclosure relates to playing cards, and more particularly to internally illuminable playing cards.

### BACKGROUND

Playing cards are traditionally made with heavy paper, thin cardboard, or a cotton-paper blend, marked with card identifiers and used as a set for card-based games. Such card identifiers typically include suits (e.g., diamonds, hearts, clubs, and spades), color (e.g., red and black), and rank or value (e.g., aces, numbers 2-10, jacks, queens, kings, and jokers), as is commonly known. Generally, the cards include the identifiers on one side (referred to as the front or face side) and a design on the other side (referred to as the back side), where the design on the back side is typically identical for each card. In addition, playing cards in a deck are typically all the same size, with each playing card in a standard 52 card deck having a length of 88.9 mm, a width of 57.15 or 63.5 mm, and a thickness of approximately 0.3 mm. In addition to card-based games (e.g., solitaire, poker, and blackjack), playing cards are used in cardistry and flourishing, both of which relate to visual manipulation of the playing cards (typically involving one or both of a user's hands) to create an aesthetically appealing motion or end display. Example cardisty/flourishing techniques include one-handed cuts, two-handed cuts, card springs, card twirls, and card fans, just to name a few techniques.

### BRIEF DESCRIPTION OF THE DRAWINGS

FIG. 1 illustrates an example internally illuminated playing card, in accordance with an embodiment of the present disclosure.

FIG. 2 illustrates an exploded view of an example internally illuminable playing card of FIG. 1 including covers and other optional layers, in accordance with some embodiments of the present disclosure.

FIG. 3 illustrates an example internally illuminated playing card, including additional componentry, in accordance with some embodiments of the present disclosure.

These and other features of the present embodiments will be understood better by reading the following detailed description, taken together with the figures herein described. The accompanying drawings are not intended to be drawn to scale. In the drawings, each identical or nearly identical component that is illustrated in various figures may be represented by a like numeral. For purposes of clarity, not every component may be labeled in every drawing.

### DETAILED DESCRIPTION

Internally illuminable playing cards are disclosed. The disclosed playing cards may include a polymeric body, at least one light-emitting diode (LED) at least partially inside of the polymeric body, a power source, such as a battery (or a slot in the polymeric body for receiving a battery), for providing power to the at least one LED, and a switch at least partially inside the polymeric body and operatively connected to the at least one LED to facilitate turning the at least one LED on and off. As can be understood based on this disclosure, the internally illuminable playing cards can be used for flourishing and cardistry techniques, in a manner similar to the way typical paper playing cards are used for such techniques. Accordingly, in some cases, the playing cards may be formed to be a similar size as typical playing cards, to allow a user to intuitively use the playing cards described herein for typical playing card applications. Numerous configurations and variations will be apparent in light of the present disclosure.

General Overview

As previously described, paper playing cards are commonly used in cardistry and flourishing, which relate to visual manipulation of the playing cards to create an aesthetically appealing motion or end display. Although advances in cardistry/flourishing techniques have been made in the recent past, the tools used in the industry (e.g., the playing cards) have essentially remained unchanged, with advancements only coming in the form of the visual designs printed on the playing cards. Therefore, there is a need for improving playing cards, especially for use in the cardistry and flourishing fields.

Thus, and in accordance with some embodiments of the present disclosure, internally illuminable playing cards are disclosed. In some embodiments, each playing card may include a body and additional components (e.g., one or more light-emitting diodes (LEDs), wiring, battery, switch, and so forth) that are at least partially embedded in and/or attached to the playing card body. In some embodiments, the playing card body may be primarily formed of a polymeric or plastic material, such as acrylic (e.g., polyacrylate), butyrate (e.g., cellulose acetate butyrate), polycarbonate, clear polypropylene, or PETG (polyethylene terephthalate glycol-modified), to name a few example materials. In some embodiments, the playing card body may at least partially allow visible light to be transmitted therethrough, and thus, in some such embodiments, the playing cards may be transparent or at least translucent (e.g., allowing at least 50, 60, 70, 80, or 90% light transmission through the playing card). In some embodiments, the illuminable playing cards described herein may include one or more internal light sources to provide light within and from each playing card itself. Although the present disclosure primarily discusses these internal light sources in the context of LEDs, the present disclosure is not intended to be so limited unless otherwise stated. For example, in some embodiments, the playing cards may be internally illuminable using fiber optic lighting or any other suitable light source as will be apparent light of this disclosure. In some embodiments, the playing cards may include a power source (e.g., at least one battery) to power the components (e.g., included LEDs) of the playing card. In some such embodiments, the power source may be rechargeable (e.g., one or more rechargeable batteries), and a connection for recharging the power source may be also be included with the playing card.

As previously described, in some embodiments, the components included with each illuminable playing card may be at least partially embedded in the playing card material (e.g., acrylic material). In some embodiments, any or all of the playing card components may be completely embedded in the playing card material. Whether a component is partially or completely embedded in the playing card body, in some embodiments, one or more of the included components may be formed inside of the playing card body material (e.g., molded into the material), while in some embodiments, one or more of the included components may be configured to be inserted into recesses in the playing card body. In some embodiments, a component may include a combination of being formed inside of the playing card body material and also having a portion of the component configured to be inserted into a recess in the playing card body. For example, the wiring of a component (e.g., the wiring for an LED) may be molded into the body of the playing card, but the actual component itself (e.g., the LED itself) may be configured to be inserted into a recess in the playing card body. Such a configuration may be used to allow the wires to be secured in the playing card body but also allow a user to switch out the LED component as desired (e.g., to change the color or brightness of the LED used in that location). Unless otherwise stated, the playing card body is not intended to be limited to a particular configuration, and numerous variations and configurations will be apparent in light of this disclosure. For example, in some embodiments, an illuminable playing card body may include a similar length and width as a typical paper playing card, such that the length of each playing card described herein is approximately 88.9 mm and the width is approximately 57.15 mm or 63.5 mm; however, any suitable lengths and widths may be used, as will be apparent in light of this disclosure. In some such embodiments, the illuminable playing cards may be selected to have the same or similar (e.g., within 5 mm) length and width of typical paper playing cards to facilitate an intuitive transfer of cardistry/flourishing techniques from paper playing cards to the illuminable playing cards described herein.

With respect to the thickness dimension, paper playing cards typically have a thickness of approximately 0.3 mm, and in some embodiments, the illuminable playing cards described herein may include a thickness of approximately 3, 4, 5, 6, 7, 8, 9, or 10 times the thickness of typical playing cards, or any other suitable thickness, depending on the particular configuration. In some embodiments, the thickness of the illuminable playing cards described herein may be in the range of 1 to 3 mm (e.g., 2 mm plus or minus 1 mm), for instance. In some embodiments, the thickness of an illuminable playing card may be based on included components. For example, in some such embodiments, the thinnest dimension of the included light source (e.g., included LEDs) may help determine the thickness of the playing card body, such that the playing card body is the same thickness or slightly thicker (e.g., 0.1-0.5 mm thicker) to accommodate the included light source. In some embodiments, the length and/or width dimension of the illuminable playing cards may be reduced relative to the length and/or width dimension of typical paper playing cards to compensate for the relatively increased thickness used for the illuminable playing cards (compared to typical paper playing card thickness). In some such embodiments, the reduction in the length and/or width dimension may allow for typical cardistry/flourishing techniques to be performed with increased comfort as a result of the relative increase in the thickness dimension, for example. The present disclosure is not intended to be limited to any specific illuminable playing card dimensions, unless otherwise stated.

In some embodiments, the playing cards may include various suitable componentry. For example, in embodiments where each playing card includes one or more LEDs and at least one battery, each playing card may include wiring connecting the battery to the LEDs and may also include a switch or other suitable mechanism to allow a user to manually turn the LEDs on and off. In some embodiments, the battery may be a 3.6 V lithium coin cell battery, for example, and the battery may be rechargeable. In some such embodiments, one or more LEDs may be operatively connected to the battery, and in instances where at least two LEDs are operatively connected to the battery, they may be connected in a parallel electrical circuit, such that the 3 V is distributed to each LED. For example, in embodiments including the 3.6 V lithium coin cell battery, up to six LEDs may be effectively operated by connecting them in parallel to the battery. Further, in such embodiments, the electrical circuit need not include any resistors. However, in some embodiments, the electrical circuit included in an illuminable playing card may include one or more resistors, depending on the configuration. Any suitable LEDs may be used for the illuminable playing cards, as will be apparent in light of this disclosure. In some embodiments, cuboid type LEDs may be used, such as ones having dimensions of 2×3×4 mm, for example. In such an example embodiment, the 2 mm dimension of the LEDs may be aligned with the thickness of the illuminable playing card to minimize the thickness of the playing card while also ensuring the LED is fully encompassed by the playing card body. Any suitable color LEDs may be used in the illuminable playing cards, and such LEDs may include single color LEDs (e.g., super bright green, white, blue, red, and so forth) and/or multi-color LEDs (e.g., using an RGB LED).

In some embodiments, the playing cards may include covers on one or both of the sides of the playing card, as will be apparent in light of this disclosure. In some such embodiments, the covers may be formed of a thin film of a polymeric or plastic material and may include a design, for example. In some embodiments, at least a portion of the covers may be opaque. The covers, where included, may be configured to be removably attached to the playing card using any suitable means, such as a fasteners (e.g., hook and loop fasteners), adhesives, slots on the playing card that the covers insert into, or any other suitable means, as will be apparent in light of the present disclosure. In some embodiments, the covers may at least partially allow visible light to be transmitted through them, and thus, in some such embodiments, the covers may be transparent or at least translucent (e.g., allowing at least 50, 60, 70, 80, or 90% light transmission through the covers). Where included, different portions of the cover may include different portions with varying amounts of light transmission allowance, such that the light source in the playing card assists with the design of the one or more covers. In some embodiments, the covers may assist with the visual effects produced by cardistry/flourishing techniques performed using the illuminable playing cards described herein, for example. In some embodiments, the playing cards may include a number of other components, such as one or more sensors (e.g., accelerometers, gyroscopes, light sensors, etc.), cameras, displays, microcontrollers, microprocessors, memory/storage, communication modules, antennas, microphones, speakers, vibrating mechanisms, and/or control features, to name a few examples, as will be apparent in light of this disclosure. In some cases, and in accordance with some embodiments, a playing card as variously described herein can be configured, for example, as: (1) a partially/completely assembled playing card, either by itself or as a deck, set, or pack of one or more playing cards; and/or (2) a kit or other collection of discrete components (e.g., a playing card body, one or more LEDs, an included or not included battery, etc.) which may be configured to assemble as described herein. Numerous configurations and variations will be apparent in light of this disclosure.

Example Internally Illuminable Playing Cards

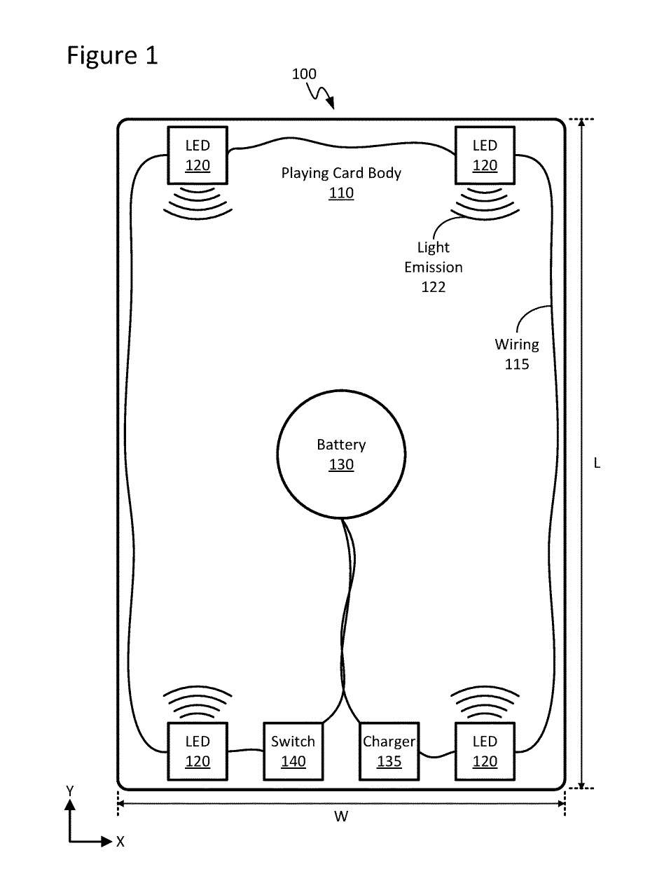

FIG. 1 illustrates an example internally illuminated playing card 100, in accordance with an embodiment of the present disclosure. As shown, the playing card 100 includes a body 110, four LEDs 120, a battery 130, a battery charger 135, a switch 140, and wiring 115, in this example embodiment. As can be understood based on this disclosure, the componentry (e.g., LEDs 120, battery 130, switch 140, charger 135, and wiring 115 connecting the various components) of the internally illuminated playing card 100 are shown as being completely embedded in playing card body 110. In some such embodiments, embedding the components within the playing card body 110, whether by forming the components therein or forming one or more recesses, slots, or other such features within and/or through the playing card body and inserting the components therein, may allow for a user to manipulate the playing card 100 without the internal components affecting that manipulation, such as in the case of using the playing card 100 for cardistry/flourishing techniques, for example. In some embodiments, one or more of the components need not be completely embedded in the playing card body, and may only be partially embedded in the playing card body. For example, it may be desired to have a portion of switch 140 extend from the playing card body 110 to allow a user to manipulate the switch (e.g., via a push button, toggle, rotating knob, etc.). Note that internally illuminable playing card 100 is referred to as a playing card herein for ease of description, and in some embodiments, it may include similar dimensions as a typical paper playing card and/or may be used for similar purposes (e.g., for flourishing and cardistry techniques). However, in some embodiments, the internally illuminable playing card 100 may be referred to as an internally illuminable card, as it may be used for any suitable reason, and is not intended to be limited to playing card purposes.

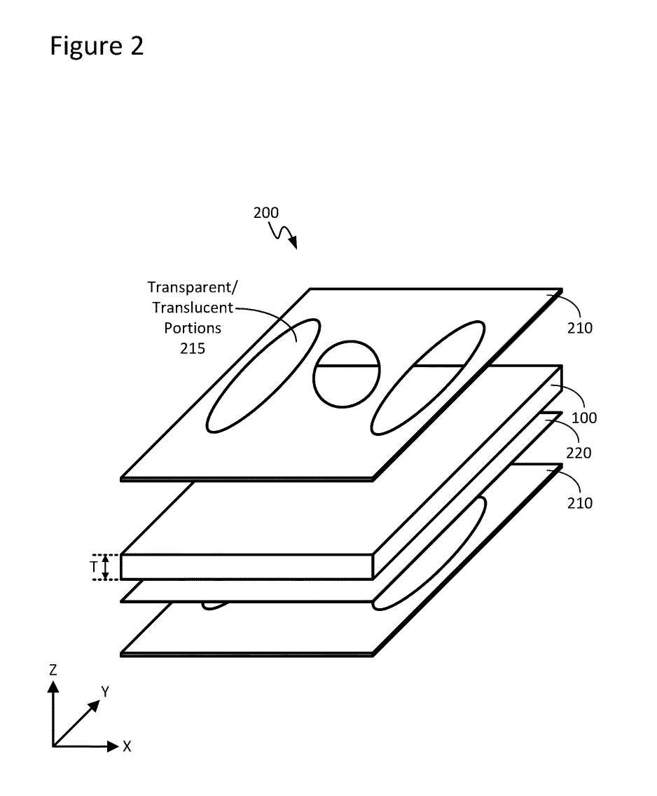

Playing card body 110, in some embodiments, may be formed of one or more polymeric or plastic materials, such as acrylic (e.g., polyacrylate), butyrate (e.g., cellulose acetate butyrate), polycarbonate, clear polypropylene, and/or PETG (polyethylene terephthalate glycol-modified), to name a few example materials. In some such embodiments, the playing card body 110 including polymeric material may have a hard or rigid structure, such that the body holds its shape without any assistance and resists deformation and bending, for example. In other embodiments, the material may be flexible, similar to that of a playing card. In some embodiments, the playing card body 110 may at least partially allow visible light to be transmitted therethrough, and thus, in some such embodiments, the playing cards may be transparent (e.g., allowing 100% light transmission through the playing card body), substantially transparent (allowing 95% or greater light transmission through the playing card body) or at least translucent (e.g., allowing at least 50, 60, 70, 80, or 90% light transmission through the playing card body). In this manner, the internal illumination within the playing card allows for light to emit at least partially through and from the playing card body 110, as can be understood based on this disclosure. In some embodiments, the playing card body 110 may be substantially clear, while in other embodiments, the playing card body 110 may include color in the body material. As will be apparent in light of this disclosure, the LEDs 120 included in the playing card may emit white and/or colored light. Therefore, in some embodiments, the color of the playing card body 110 and the color of the LEDs 120 may be selected based on a desired visual result. Further, in some embodiments, the color and/or design of any included covers 210 for the playing card 100 (discussed with reference to FIG. 2) may also be selected based on a desired visual result.

As is also shown in FIG. 1, playing card body 110 is generally shaped similar to a traditional paper playing card, in this example embodiment, and includes length dimension L and width dimension W. The playing card in this example embodiment also includes a thickness dimension T that would be the dimension going into/coming out of the page (and is illustrated in FIG. 2). In some embodiments, the dimensions L, W, and T of the playing card 100 may be selected to be similar to a traditional paper playing card, such that use of playing card 100 in areas such as cardisty/flourishing may be more intuitively performed. Thus, in some embodiments, the length L of playing card 100 may be 88.9 mm plus or minus 10 mm, the width W may be 60 mm plus or minus 10 mm, and the thickness T may be 2 mm plus or minus 1 mm; however, the present disclosure is not intended to be so limited, unless otherwise stated. For instance, in some embodiments, the length L of playing card 100 may be in the range of 50 to 120 mm, the width W may be in the range of 20 to 100 mm, and the thickness T may be in the range of 0.3 to 5 mm, for example, or any other suitable value, as will be apparent in light of this disclosure. In some embodiments, the ratio of the length to the width (L:W) of playing card 100 may be at least 1, 1.5, 2, 2.5, 3, 3.5, or 4, or some other suitable threshold value, as will be apparent in light of the present disclosure. In some embodiments, the thickness T of playing card 100 may be at most 2, 3, 4, 5, 6, 7, 8, 9, or 10 times as thick as the thickness of a typical paper playing card (approximately 0.3 mm), or less than some other suitable value, as will be apparent in light of the present disclosure.

In some embodiments, the thickness of playing card 100 may be based on included components. For example, in some such embodiments, the thinnest dimension of LEDs 120 may help determine the thickness of the playing card body 110, such that the playing card body is the same thickness or slightly thicker (e.g., 0.1-0.5 mm thicker) to accommodate the included LEDs 120. In some embodiments, the length L and/or width W dimension of the playing card 100 may be reduced relative to the length L and/or width W dimension of typical paper playing cards to compensate for the relatively increased thickness T used for the playing card 100 (compared to typical paper playing card thickness). In some such embodiments, the reduction in the length L and/or width W dimension may allow for typical cardistry/flourishing techniques to be performed with increased comfort as a result of the relative increase in the thickness T dimension, for example. In some embodiments, one or more of the included components of playing card 100 described herein (e.g., LEDs 120, battery 130, wiring 115, etc.) may be integrally formed inside the material of playing card body 110 or otherwise formed inside the playing card body 110, for example. In some embodiments, one or more of the included components of playing card 100 described herein may be configured to be inserted or otherwise installed in one or more slots, recesses, apertures, gaps, holes, voids, or other similar features in playing card body 110, such that the one or more components can be removably or non-removably (e.g., not being able to be removed without materially altering the component and/or the body) inserted into the playing card body 110, for example. As previously described, insertion of a given component in playing card body 110 may be partial (e.g., where a portion of the given component at least partially extends from playing card body 110) or complete (e.g., where no portion of the given component extends from playing card body 110). In some embodiments, one or more of the included components of playing card 100 described herein may be removably or non-removably attached to the outside of playing card body 110, for example. The present disclosure is not intended to be limited to any specific illuminable playing card dimensions or configurations, unless otherwise stated.

LEDs 120, in some embodiments, may include any suitable LEDs, as will be apparent in light of this disclosure. As previously described, although the light sources included in playing card 100 in this example embodiment are LEDs 120, the present disclosure is not intended to be so limited. For example, in some embodiments, playing card 100 may include any suitable light source, such as fiber optic lighting or any other suitable light source as will be apparent in light of this disclosure. Generally, LEDs 120 may be any solid-state light source, such as an LED, an organic LED (OLED), a polymer LED (PLED), and/or any combination thereof. A given solid-state light source may be configured to emit electromagnetic radiation (e.g., light), for example, from the visible spectral band and/or other portions of the electromagnetic spectrum, such as the infrared (IR) spectral band and/or the ultraviolet (UV) spectral band, to name a few examples. In this example embodiment, the electromagnetic radiation emitted from LEDs 120 is visible light; however, the present disclosure is not intended to be so limited. In the example embodiment of FIG. 1, four LEDs 120 are included as shown; however, an internally illuminable playing card may include any suitable number of LEDs. For example, playing card 100 may include 1, 2, 3, 4, 5, 6, 7, 8, 9, 10, or more LEDs 120, as can be understood based on this disclosure. In some embodiments, LEDs 120 may be selected to emit any suitable color of light, such as red, orange, yellow, green, blue, violet, purple, pink, or white, to name a few examples, depending on the end use or target application. In some embodiments, LEDs 120 may be selected to have any suitable brightness, depending on the end use or target application, and such brightness may be affected based on the electrical circuit utilized in playing card 100. In some embodiments, the color, brightness, and/or on/off state of the individual LEDs 120 may be tunable or otherwise customizable, based on manual input (e.g., user-based) and/or other input (e.g., from one or more sensors, such as a microphone, accelerometer, and/or gyroscope).

In embodiments where playing card 100 includes multiple LEDs 120, they may be electrically connected to a power source (battery 130, in this example case) using a parallel circuit to provide suitable voltage/current to each LED 120. In some such embodiments, the battery 130 and LEDs 120 may be selected based on what is used for the other component(s). More specifically, the type of LEDs 120 used in playing card 100 may dictate a suitable battery 130 and vice versa. For example, in the case of using a 3.6 V lithium coin cell battery, the capacity of the battery may be 20 mAh, which can be used to effectively operate up to six LEDs. In some embodiments, wiring 115 may include any suitable wiring configured to allow for electrical connection of the components of playing card 100, such as LEDs 120. For instance, in the example embodiment shown in FIG. 1, wiring 115 operatively connects LEDs 120 to switch 140 and battery 130, and wiring 115 also connects battery charger 135 to battery 130. In some embodiments, wiring 115 may include electrical insulation on the outside. Note that in some embodiments, one or more of the components of playing card 100 may be wireless, such that wiring 115 need not be required for every component of playing card 100, for example.

In some embodiments, the one or more LEDs 120 may be installed or be configured to be inserted in playing card body 110 in any suitable location. For example, as shown in FIG. 1, the four LEDs are included near the outside edge of the top and bottom of the playing card body 110. However, the present disclosure is not intended to be so limited. For instance, in some embodiments, one or more included LEDs 120 may be included or be configured to be inserted at any position in playing card body 110. Further, as previously described, in some embodiments, one or more included LEDs 120 may be attached to or be configured to be attached to any portion of the outside of playing card body 110. Therefore, included LEDs 120 are not intended to be limited to any specific position, unless otherwise stated. As LEDs are typically directional light sources, meaning that they emit light in a specific direction (e.g., as opposed to incandescent and fluorescent light sources), the one or more LEDs 120 included in playing card 100 may also be oriented in any desired direction relative to playing card body 110. In the example embodiment of FIG. 1, the four LEDs 120 are oriented such that the light emission 122 from each LED 120 is directed generally toward the center of playing card body 110. Specifically, in this example embodiment, the LEDs 120 are oriented such that each LED 120 directs its light emission 122 toward an opposite LED 120 (opposite relative to the length or longest dimension of playing card body 110), as shown. In such an example embodiment, the LEDs 120 may be oriented as such to allow for the light emitted from each LED 120 to diffuse into playing card body 110 and provide a visually appealing effect. However, any included LEDs 120 may be oriented in any suitable direction relative to playing card body 110 (and its included components), and the present disclosure is not intended to be limited to any specific orientation of included LEDs, unless otherwise stated. For instance, in another example embodiment, included LEDs may be oriented such that light emits in an outward direction relative to playing card body 110 (e.g., if the LEDs 120 in FIG. 1 were all rotated 180 degrees). Numerous LED position and orientation configurations will be apparent in light of this disclosure. Moreover, the other components included with playing card 100 (such as battery 130, switch 140, etc.) are not intended to be limited to any specific position or orientation relative to playing card body 110, unless otherwise stated.

Battery 130, in some embodiments, may include any suitable battery to provide power to one or more of the components of playing card 100, such as to power LEDs 120, for example. In some embodiments, only one battery 130 may be installed in or be configured to be installed in playing card body 110, while in other embodiments, playing card body 110 may include or be configured to receive multiple batteries. Therefore, reference to a battery herein (such as battery 130) means at least one battery, unless otherwise stated. For instance, in some embodiments, the at least one battery 130 may be a coin cell battery, such as a lithium coin cell battery, which is typically flat and thus well suited for playing card 100. In some such embodiments, the at least one battery 130 may supply any suitable voltage, such as a voltage in the range of 0.5 to 12 volts, or any other suitable voltage as will be apparent in light of this disclosure. In an example embodiment, battery 130 is a 3.6 V lithium coin cell battery. In some embodiments, the at least one battery 130 may provide any suitable capacity, such as a capacity of 5 to 50 mAh, or any other suitable capacity as will be apparent in light of this disclosure. In some embodiments, the capacity and/or voltage of the included battery(ies) may dictate the number of LEDs that can be effectively operated.

In some embodiments, playing card 100 may include the at least one battery 130 internally in playing card body 110, such that the at least one battery 130 is non-replaceable. In some embodiments, playing card 100 may include a slot, recess, or other similar feature in playing card body 110 that is configured to receive the at least one battery 130, such that the at least one battery 130 may be replaceable. In some such embodiments, the at least one battery 130 may be provided with playing card 100 but external to playing card body 110 prior to use, such that a user has to insert or otherwise install battery 130 in body 110, for example. Further, in some such embodiments, battery 130 may not be provided with playing card 100, and may instead need to be provided separately by a user. In some embodiments, battery 130 (or batteries, when multiple are included) may be rechargeable, and recharging may be facilitated, for example, by removing battery 130 and recharging it external from playing card 100 and/or using battery charger 135, which is described in more detail below. Note that although the power source for playing card 100 is primarily described herein as at least one battery (i.e., one or more batteries), the present disclosure is not intended to be limited to such a specific power source for playing card 100, unless otherwise stated. For example, in some embodiments, playing card 100 may include a capacitor and a system for charging the capacitor, such as a mechanically powered system (e.g., that is powered via shaking, spinning, turning a crank, etc.).

Battery charger 135, in some embodiments, may be included with playing card 100 to allow for recharging of battery 130, for example. In some such embodiments, battery charger 135 may be operatively connected to battery 130 (or to multiple batteries, in embodiments including more than one battery). Battery charger 135 may include any suitable componentry, such as a connector configured to attach to an external plug or adapter and allow charging of battery 130 when the external plug/adapter is connected to a power source, for example. In some such embodiments, the external plug/adapter may be included with playing card 100 to allow users to charge battery 130. Note that in embodiments of playing card 100 where battery 130 is removable, battery charger 135 may be operatively coupled to the battery connections within the slot or recess (or other similar feature) in playing card body 110, for example, to allow for charging of a battery when one is inserted. Also note that in some embodiments, one or more of the components in the example playing card of FIG. 1 need not be included. For example, battery charger 135 need not be included, particularly in embodiments where the one or more batteries of playing card 100 are removable and thus replaceable.

Switch 140, in some embodiments, may be included with playing card to allow a user to manually turn LEDs 120 on and off, for example. In some embodiments, switch 140 may include any suitable electrical switch component that is configured to interrupt the flow of electrons in the circuit included with playing card 100, for example. For instance, switch 140 may be operatively connected to the included LEDs 120 and/or battery 130 to allow and prevent voltage to flow from the battery to the LEDs, in some embodiments. In some embodiments, switch 140 may be operated using any suitable mechanism, such as a toggle, a pushbutton, a capacitive switch, a selector, a knob, a joystick, a lever, and/or any other suitable mechanism as will be apparent in light of this disclosure. In some such embodiments, the mechanism for operating switch 140 may be embedded or recessed in playing card body 110, such that a user can manually manipulate the mechanism when desired, but accidental operation of the mechanism is reduced or eliminated. This can be useful when using playing card 100 for flourishing/cardisty techniques, as a user's hands and fingers may be making contact with many portions of the playing card body 110 during such techniques. Numerous other suitable components for playing card 100 will be apparent in light of this disclosure.

FIG. 2 illustrates an exploded view of an example internally illuminable playing card 200 of FIG. 1 including covers 210 and other optional layers, in accordance with some embodiments of the present disclosure. In this example embodiment, playing card 200 includes previously described playing card 100 and two covers 210 that may be removably or non-removably (e.g., not being able to be removed without materially altering the cover and/or the playing card body 110) attached to playing card 100. Note that the playing cards variously described herein may have no covers, one cover (e.g., covering a substantial portion of one or more sides of the card), two covers, or more covers. For instance, in one example embodiment, a single cover may wrap around the playing card body, such that it substantially covers three sides of the playing card body. As previously described and as shown, in the example embodiment of FIG. 2, two covers 210 are included. In some embodiments, covers 210 may be configured to be removably attached to playing card 100 using any suitable means. For example, in some such embodiments, cover 210 may be removably attached to playing card 100 in various suitable ways, such as via a hook and loop fastener system, via a snap or compression fit, via sliding cover 210 into retention portions on playing card 100 (e.g., flexing cover 210 and inserting all four corners into retention portions near the four corners of playing card 100), via a magnetic system, or via some other suitable system or mechanism that allows covers 210 to be removably attached to playing card 100, as will be apparent in light of this disclosure. In some embodiments, covers 210 may be non-removably attached to playing card 100, using any suitable means, such as via an adhesive, via melting the materials together, or via some other mechanism that allows the covers 201 to be non-removably attached to playing card 100, as will be apparent in light of this disclosure.

In some embodiments, covers 210 may be shaped to have lengths and/or widths similar to that of playing card 100. However, in some embodiments, covers 210 may have lengths and/or widths that are smaller than that of playing card 100. In some embodiments, covers 210 may include designs, graphics, artwork, or other visual markings. In some such embodiments, the visual markings may relate to typical paper playing cards. For example, one of the covers 210 may include a design similar to that on the back of a typical paper playing card, while the other cover may include a suit (e.g., heart, diamond, spade, or club) and number or face value (e.g., 2-10, jack, queen, king, or ace) to indicate the specific playing card it is intended to represent. In some embodiments, included covers 210 may include designs that correspond to the components of playing card 100. For example, in some embodiments, covers 210 may include translucent or transparent portions 215 (e.g., portions that are at least transparent) that allow for light to emit through covers 210 in a desired manner. Further, in some embodiments, covers 210 may include opaque (or substantially opaque) portions to allow light to emit through covers 210 in a desired manner (e.g., placing opaque portions over the LED light source to help block the brightest portion of the light). In another example, in some such embodiments, the covers 210 may include a translucent or transparent portion 215 that allows a component of playing card 100 to be seen through the covers 210, such as the covers in FIG. 2 that have a circular transparent/translucent portion to allow a user to see through the cover and see the battery 130 in the center of the playing card body 110. In some embodiments, playing card body 110 may also or alternatively include designs, graphics, artwork, or other visual markings, whether such visual markings are on the surface of the playing card body 110, within the playing card body 110, or some combination thereof.

In some embodiments, the playing cards variously described herein may include one or more films on one or more sides of the playing card body, for numerous suitable purposes. For instance, in the example embodiment shown in FIG. 2, film 220 is included in the exploded view, where film 220 may be attached to one or more sides of playing card 100 (shown in FIG. 2 as being configured to attach to only one side). In this example embodiment, film 220 may be included to affect light emission from playing card 100, strengthen playing card 100, provide a design to playing card 100, and/or for any other suitable purpose as will be apparent in light of this disclosure. In an example embodiment, film 220 may be a matte film (e.g., a matte PVC film) configured to adhere to playing card 100 to affect light transmission therethrough. In such an example embodiment, the matte PVC film may cause light emitted from playing card 100 to be softer and/or more visually appealing, for example.

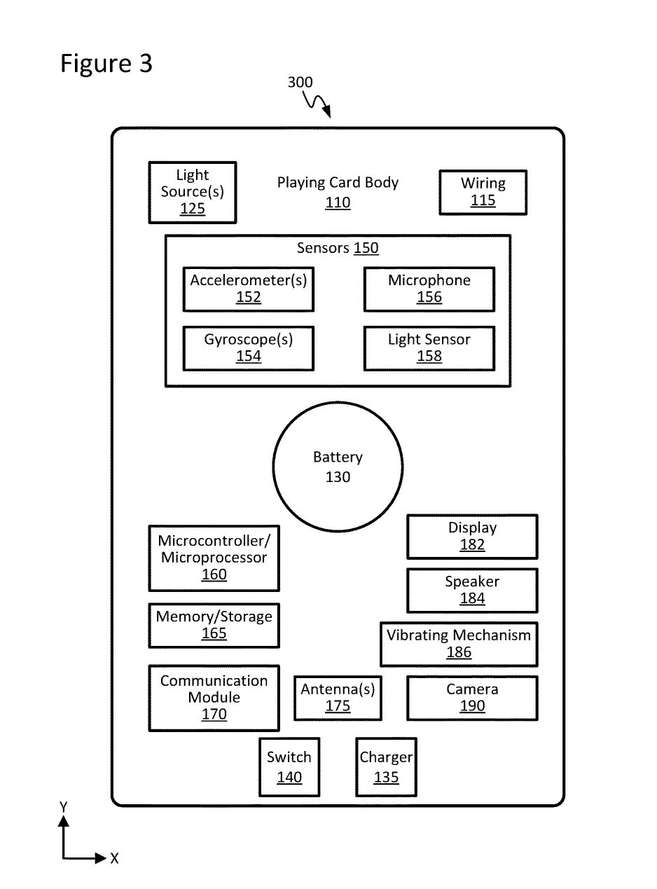

FIG. 3 illustrates an example internally illuminated playing card 300, including additional componentry, in accordance with some embodiments of the present disclosure. As shown in FIG. 3, playing card 300 includes some components included with playing card 100 of FIG. 1. For example, in this example embodiment, playing card 300 also includes playing card body 110, wiring 115, at least one battery 130, battery charger 135, and switch 140, as well as light source(s) 125, which may include one or more LEDs as described herein (e.g., LEDs 120). Therefore, the previous relevant description of those components is equally applicable to the playing card 300. However, as shown in FIG. 3, playing card 300 may include additional componentry, in some embodiments. The additional components shown in FIG. 3 include sensors 150 (e.g., accelerometer(s) 152, gyroscope(s) 154, microphone 156, light sensor 158), microcontroller/microprocessor 160, memory/storage 165, communication module 170, antenna(s) 175, display 182, speaker 184, vibrating mechanism 186, and camera 190, in this example embodiment. Note that the playing cards as variously described herein may include one or more other suitable components, as can be understood based on this disclosure. Further, note that in some embodiments, one or more of the components shown in playing card 300 may be optional and thus may not be included. For instance, in some embodiments, playing card 300 need not even include light source(s) 125, such that it is not internally illuminable, but may instead include one or more sensors (e.g., an accelerometer and/or gyroscope) to measure the manipulation of the card (e.g., when performing various flourishing and cardistry techniques), for example. Further, in some such embodiments, the playing card may also include communication module 170 to transmit data from the included sensor(s), such as data on how fast the playing card is being manipulated (e.g., spun, twisted, rotated, flipped, thrown, etc.). Note that the position of the components shown in FIG. 3 are provided for ease of illustration and as such, their positions in playing card body 110 are not intended to limit the present disclosure. In some embodiments, the position of the components of the playing cards variously described herein, such as any included light sources (e.g., LEDs), batteries, switches, charging connectors, sensors, microcontrollers, and so forth, may be positioned in the playing card body in such a manner so as to approximately distribute the weight of such components in an even manner across the central Y and/or X axes of the playing cards. In some such embodiments, the approximately even distribution of weight may assist with use of the playing cards when performing flourishing/cardistry techniques, for example. For instance, in FIGS. 1 and 3, battery 130 is shown in the center of the playing cards, which assists with weight distribution.

Sensors 150 may be included in playing card 300, in some embodiments, to measure information relating to playing card 300, such as movement of the playing card, environmental audio, and/or environmental light, to name a few examples. As such, the sensors 150 shown in FIG. 3 include one or more accelerometers 152, one or more gyroscopes 154, one or more microphones 156, and one or more light sensors 158, in this example embodiment. When included, accelerometer(s) 152 may be configured as typically done, and in some example embodiments may be configured to detect motion of playing card 300, and more specifically, motion of playing card body 110. For example, included accelerometers 152 and/or gyroscopes 154 may be configured to detect: lateral movement of playing card 100 in FIG. 2 in positive and/or negative X, Y, and/or Z directions; rotations about its X, Y, and/or Z axes; and/or any other suitable movement as will be apparent in light of this disclosure. In some cases, the measurement of movement of playing card 300 may assist in gathering data related to, for example, flourishing and cardistry techniques. In some embodiments, microphone(s) 156 may include any suitable devices and may be configured as typically done. In some embodiments, light sensor(s) 158 may include any suitable devices and may be configured as typically done. In some embodiments, playing card 300 may include one or more cameras 190, which may also be considered a sensor 150. In some such embodiments, camera(s) 190 may include any suitable devices and may be configured as typically done.

In some embodiments, one or more of the included sensors 150 may be used to affect light transmitted from playing card 300. For example, in some such embodiments, the light emitted from playing card 300 (e.g., using light source(s) 125, such as one or more LEDs 120) may be adjusted based on motion measurements from one or more included accelerometers 152 and/or gyroscopes 154, based on sound measurements from one or more included microphones 156, and/or based on light measurements from one or more included light sensors 158. In embodiments including one or more sensors 150, those sensors may be operatively coupled to the at least one battery 130 (or other power source) to facilitate operation of the sensors, for example. Further, in embodiments including one or more sensors 150, the sensors may be operatively coupled to at least one of a microcontroller or microprocessor 160, memory or storage 165, and/or a communication module to facilitate collection, storage, and/or transmission of data from the one or more sensors 150, for example. Any other suitable componentry may be included to facilitate operation of included sensors 150, as can be understood based on this disclosure.

In some embodiments, playing card 300 may include a microcontroller and/or a microprocessor 160, which may include any suitable device and may be configured as typically done. In some embodiments, microcontroller/microprocessor 160 may be configured to control one or more components of playing card 300, such as the light source(s) 125 (e.g., LEDs 120), and/or to perform operations associated with playing card 300, such as determining how to adjust the light emitted from the light source(s), for example. In some embodiments, playing card 300 may include memory and/or storage 165, which may include any suitable device and may be configured as typically done. In some embodiments, memory/storage 165 can be of any suitable type (e.g., RAM and/or ROM, or other suitable memory) and size, and in some cases may be implemented with volatile memory, non-volatile memory, or a combination thereof. In some cases, memory/storage 165 may be configured to be utilized, for example, for processor workspace (e.g., for microprocessor 160) and/or to store media, programs, applications, and/or content on a temporary or permanent basis. The one or more modules stored in memory 165 can be accessed and executed, for example, by the one or more processors 160 of a given playing card. In accordance with some embodiments, a given module of memory/storage 165 can be implemented in any suitable standard and/or custom/proprietary programming language, such as, for example, C, C++, objective C, JavaScript, and/or any other suitable custom or proprietary instruction sets, as will be apparent in light of this disclosure. The modules of memory 165 can be encoded, for example, on a machine-readable medium that, when executed by a processor or microprocessor 160, carries out the functionality of a given playing card 300, in part or in whole. The computer-readable medium may be, for example, a hard drive, a compact disk, a memory stick, a server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose-built logic. Some embodiments can be implemented with a microcontroller 165 having input/output capability (e.g., inputs for receiving user inputs; outputs for directing other components) and a number of embedded routines for carrying out the device functionality. In a more general sense, the functional modules of memory 165 can be implemented in hardware, software, and/or firmware, as desired for a given target application or end-use.

In some embodiments, playing card 300 may include a communication module 170, which may include any suitable device and which may be configured for wired (e.g., Universal Serial Bus or USB, Ethernet, FireWire, etc.) and/or wireless (e.g., Wi-Fi, Bluetooth, etc.) communication, as desired. In accordance with some embodiments, communication module 170 may be configured to communicate locally and/or remotely utilizing any of a wide range of wired and/or wireless communications protocols, including, for example, a digital multiplexer (DMX) interface protocol, a Wi-Fi (or other long range communication) protocol, a Bluetooth (or other short range communication) protocol, a near field communication (NFC) (or other near or very short range communication) protocol, a digital addressable lighting interface (DALI) protocol, a ZigBee protocol, and/or a combination of any one or more thereof. It should be noted, however, that the present disclosure is not so limited to only these example communications protocols, as in a more general sense, and in accordance with some embodiments, any suitable communications protocol, wired and/or wireless, standard and/or custom/proprietary, for any desired communication range, may be utilized by communication module 170, as desired for a given target application or end-use. In some embodiments, playing card 300 may include one or more internal and/or external antennas to facilitate operation of one or more included communication modules 170, for example. In some instances, communication module 170 may be configured to facilitate communication to a computing device (e.g., a smart phone or tablet computing device) to enable transmission of data therebetween. Other suitable configurations for communication module 170 will depend on a given application and will be apparent in light of this disclosure.

In some embodiments, playing card 300 may include one or more output devices, such as one or more displays 182, speakers 184, and/or vibrating mechanisms 186, for example. In some embodiments, display(s) 182 may include any suitable device, and may include a touch sensitive or a non-touch sensitive display, for example. Such a display may be implemented using LED, liquid crystal display (LCD), and/or any other suitable display technology, depending on the end use or target application. In some embodiments, speaker(s) 184 may include any suitable devices and may be configured as typically done. In some embodiments, vibrating mechanism(s) 186 may include any suitable devices (such as an electric motor with an unbalanced weight on its driveshaft) and may be configured as typically done. In embodiments including one or more output devices, those output devices may be configured to provide visual, aural, and/or tactile feedback related to playing card 300. In embodiments including one or more output devices, those devices may be operatively coupled to the at least one battery 130 (or other power source) to facilitate operation of the devices, for example. Further, in embodiments including one or more output devices, the devices may be operatively coupled to at least one of a microcontroller or microprocessor 160, memory or storage 165, and/or a communication module to facilitate operation of the output devices, for example. Any other suitable componentry may be included to facilitate operation of included output devices, such as one or more displays 184, speakers 184, and/or vibrating mechanisms 186, as can be understood based on this disclosure. Numerous variations and configurations will be apparent in light of this disclosure.

Numerous embodiments will be apparent in light of this disclosure. One example embodiment provides a device including an internally illuminable playing card including: a card-shaped body formed of a polymeric material that is at least one of transparent and translucent; at least one light-emitting diode (LED) at least partially inside the body; a slot formed in the body and configured to receive a battery for providing power to the at least one LED; and a switch at least partially inside the body and operatively connected to the at least one LED. In some cases, the body includes acrylic material. In some cases, the slot is configured to receive a 3.6 V lithium coin cell battery. In some cases, the playing card further includes a battery charging connector configured to charge a battery inserted in the slot. In some cases, the playing card includes multiple LEDs operatively connected to the switch in a parallel circuit. In some cases, the body has a length between 75 mm and 100 mm, a width between 50 mm and 70 mm, and a thickness between 1 mm and 3 mm. In some cases, the playing card further includes at least one cover configured to removably attach to at least one side of the body. In some cases, the at least one LED includes a direction of light emission, the direction being toward an approximate center of the body. In some cases, the playing card further includes at least one of an accelerometer and a gyroscope. In some such cases, the playing card further includes memory configured to store data related to the at least one of an accelerometer and gyroscope. In some such cases, the playing card further includes a communication module configured to transmit the data to a computing device. In some cases, the playing card further includes a microcontroller configured to control light emitted from the at least one LED. In some cases, light emitted from the at least one LED is automatically controlled based on at least one of movement of the body, audio input, and a preconfigured program.

Another example embodiment provides an internally illuminable playing card including: a body formed of a polymeric material that is substantially translucent, wherein the body has a length between 75 mm and 100 mm, a width between 50 mm and 70 mm, and a thickness between 1 mm and 3 mm; a battery at least partially inside the body and centrally positioned in the body; multiple light-emitting diodes (LEDs) at least partially inside the body and operatively connected to the battery in a parallel circuit; and a switch at least partially inside of the polymeric body and operatively connected to the LEDs. In some cases, the body allows at least 70% transmission of light therethrough. In some cases, the playing card further includes a thin matte film on at least one side of the body. In some cases, the playing card further includes two covers, each cover removably attached to a side of the body. In some such cases, at least one of the covers is one of transparent and translucent in a portion over the battery.

Another example embodiment provides a method of forming an internally illuminable playing card, the method including: providing a body of a polymeric material that is at least translucent; providing at least one light-emitting diode (LED) at least partially inside the body; providing a battery at least partially inside the body, the battery configured to power the at least one LED; and providing a switch at least partially inside the body, wherein the switch is operatively connected to the at least one LED. In some cases, at least one of the battery, the at least one LED, and the switch are provided completely inside of the body.

The foregoing description of example embodiments has been presented for the purposes of illustration and description. It is not intended to be exhaustive or to limit the present disclosure to the precise forms disclosed. Moreover, it should be noted that the language used in the specification has been selected principally for readability and instructional purposes and not to limit the scope of the inventive subject matter. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

1. An internally illuminable playing card comprising:
a card-shaped body formed of a polymeric material that is at least one of transparent and translucent;
at least one light-emitting diode (LED) at least partially inside the body;
a slot formed in the body and configured to receive a battery for providing power to the at least one LED; and
a switch at least partially inside the body and operatively connected to the at least one LED.

2. The internally illuminable playing card of claim 1, wherein the body includes acrylic material.

3. The internally illuminable playing card of claim 1, wherein the slot is configured to receive a 3.6 V lithium coin cell battery.

4. The internally illuminable playing card of claim 1, further comprising a battery charging connector configured to charge a battery inserted in the slot.

5. The internally illuminable playing card of claim 1, wherein the playing card includes multiple LEDs operatively connected to the switch in a parallel circuit.

6. The internally illuminable playing card of claim 1, wherein the body has a length between 75 mm and 100 mm, a width between 50 mm and 70 mm, and a thickness between 1 mm and 3 mm.

7. The internally illuminable playing card of claim 1, further comprising at least one cover configured to removably attach to at least one side of the body.

8. The internally illuminable playing card of claim 1, wherein the at least one LED includes a direction of light emission, the direction being toward an approximate center of the body.

9. The internally illuminable playing card of claim 1, further comprising at least one of an accelerometer and a gyroscope.

10. The internally illuminable playing card of claim 9, further comprising memory configured to store data related to the at least one of an accelerometer and gyroscope.

11. The internally illuminable playing card of claim 10, further comprising a communication module configured to transmit the data to a computing device.

12. The internally illuminable playing card of claim 1, further comprising a microcontroller configured to control light emitted from the at least one LED.

13. The internally illuminable playing card of claim 12, wherein light emitted from the at least one LED is automatically controlled based on at least one of movement of the body, audio input, and a preconfigured program.

14. An internally illuminable playing card comprising:
a body formed of a polymeric material that is substantially translucent, wherein the body has a length between 75 mm and 100 mm, a width between 50 mm and 70 mm, and a thickness between 1 mm and 3 mm;
a battery at least partially inside the body and centrally positioned in the body;
multiple light-emitting diodes (LEDs) at least partially inside the body and operatively connected to the battery in a parallel circuit; and
a switch at least partially inside of the polymeric body and operatively connected to the LEDs.

15. The playing card of claim 14, wherein the body allows at least 70% transmission of light therethrough.

16. The playing card of claim 14, further comprising a thin matte film on at least one side of the body.

17. The playing card of claim 14, further comprising two covers, each cover removably attached to a side of the body.

18. The playing card of claim 17, wherein at least one of the covers is one of transparent and translucent in a portion over the battery.

19. A method of forming an internally illuminable playing card, the method comprising:
providing a body of a polymeric material that is at least one of transparent and translucent;
providing at least one light-emitting diode (LED) at least partially inside the body;
forming a slot in the body, the slot configured to receive a battery for providing power to the at least one LED; and
providing a switch at least partially inside the body, wherein the switch is operatively connected to the at least one LED.

20. The method of claim 19, wherein at least one of the slot, the at least one LED, and the switch are provided completely inside of the body.
